(19) United States
(12) Patent Application Publication
(10) Pub. No.: US 2018/0295766 A1
(43) Pub. Date: Oct. 18, 2018

(54) TWO-HANDLED SHOVEL

(71) Applicant: Ergieshovel, LLC, WESTFIELD, MA (US)

(72) Inventor: RALPH THRESHER, Westfield, MA (US)

(21) Appl. No.: 15/947,022

(22) Filed: Apr. 6, 2018

Related U.S. Application Data
(60) Provisional application No. 62/484,536, filed on Apr. 12, 2017.

(51) Int. Cl. A01B 1/02

(52) U.S. Cl. CPC A01B 1/026; B25G 1/102

(57) ABSTRACT

A utility apparatus includes an elongated shaft having a first end and a second end, a utility head affixed to the second end of the elongated shaft and a first handle affixed to the first end of the elongated shaft. The utility apparatus further includes a secondary shaft affixed to the elongated shaft along a middle third of the elongated shaft and extending rearwards generally toward the first handle. A second handle is affixed to the distal end of the secondary shaft. The second handle extends at an angle between approximately 40 degrees and 70 degrees from the elongated shaft.

### CROSS-REFERENCE TO RELATED APPLICATIONS

This application claims the benefit of U.S. Provisional Application Ser. No. 62/484,536, filed on Apr. 12, 2017, which is hereby incorporated by reference herein in its entirety.

### FIELD OF THE INVENTION

The present invention relates generally to utility apparatuses such as shovels and, more particularly, to a two-handled shovel.

### BACKGROUND OF THE INVENTION

Various utility apparatuses for moving various types of materials are known in the art. Examples of such apparatuses include, but are not limited to, rakes for moving dirt, leaves and the like, pitchforks for picking up loose materials such as hay, stray, leaves or mulch, hoes for moving and turning dirt, brooms for sweeping sawdust and other fine materials, and shovels for moving various materials such as snow.

Existing snow shovels, for example, come in several different designs, each of which is designed to move snow in a different way. Removing snow with a snow shovel has health risks, but can also have significant health benefits when the snow shovel is used correctly. Shoveling snow using a straight shaft snow shovel requires the user to bend over and lift. As the user bends over repeatedly, they typically experience back pain and fatigue within a short period of time.

In view of the above, there is a need for a shovel that reduces the need to bend over to lift the snow load, thereby reducing the stress on the back. Similarly, there is a need for other utility apparatuses that are likewise more ergonomic than existing designs and which reduce the stress on a user's back.

### SUMMARY OF THE INVENTION

The present invention provides a new and unique two-handled shovel which is simple and cost-effective to manufacture, and which is particularly useful for shoveling snow and dirt, or any other appropriate product.

It is an object of the present invention to provide a utility apparatus for moving material that is more ergonomic than existing devices.

It is another object of the present invention to provide a utility apparatus for moving material that reduces the stress on a user's back.

These and other objects are achieved by the present invention.

According to an embodiment of the present invention, a utility apparatus is provided. The utility apparatus includes an elongated shaft having a first end and a second end, a first handle affixed to the first end of the elongated shaft, a utility head affixed to the second end of the elongated shaft, an auxiliary shaft extending from the elongated shaft, the auxiliary shaft having a first end rigidly affixed to the elongated shaft and a second end opposite the first end, and a second handle affixed to the second end of the auxiliary shaft. The auxiliary shaft forms an angle between about 40 degrees and about 70 degrees with the elongated shaft, and the auxiliary shaft is attached to the elongated shaft at a point along a middle third of the elongated shaft.

According to another embodiment of the present invention, a utility apparatus is provided. The utility apparatus includes an elongated shaft having a first end and a second end, a first handle affixed to the first end of the elongated shaft, a shovel head affixed to the second end of the elongated shaft, an auxiliary shaft extending from the elongated shaft, the auxiliary shaft having a first end rigidly affixed to the elongated shaft and a second end opposite the first end, and a second handle affixed to the second end of the auxiliary shaft. The auxiliary shaft forms an angle between about 40 degrees and about 70 degrees with the elongated shaft. The auxiliary shaft is attached to the elongated shaft at a point along a middle third of the elongated shaft, the second handle is positioned at a distance between about 4 inches and about 18 inches above the elongated shaft, and the second handle is positioned at a distance between about 14 inches and about 26 inches from the first handle.

According to yet another embodiment of the present invention, a shovel is provided. The shovel includes an elongated shaft having a first end and a second end, a first handle affixed to the first end of the elongated shaft, a shovel head affixed to the second end of the elongated shaft, an auxiliary shaft extending from the elongated shaft, the auxiliary shaft having a first end rigidly affixed to the elongated shaft and a second end opposite the first end, and a second handle affixed to the second end of the auxiliary shaft. The auxiliary shaft forms an angle between about 40 degrees and about 70 degrees with the elongated shaft, and the auxiliary shaft is attached to the elongated shaft at a point along a middle third of the elongated shaft. The elongated shaft has a length between about 24 inches and about 72 inches, the auxiliary shaft has a length between about 6 inches and 16 inches, the second handle is positioned approximately 14 inches above the elongated shaft, and the second handle is positioned at a distance of approximately 21 inches from the first handle.

### BRIEF DESCRIPTION OF THE DRAWINGS

The present invention will be better understood from reading the following description of non-limiting embodiments, with reference to the attached drawings, wherein below:

FIG. 1 is a perspective view of a two-handled shovel according to an embodiment of the present invention.

FIG. 2 is a schematic illustration of a two-handled shovel according to an embodiment of the present invention.

### DETAILED DESCRIPTION OF THE PREFERRED EMBODIMENT

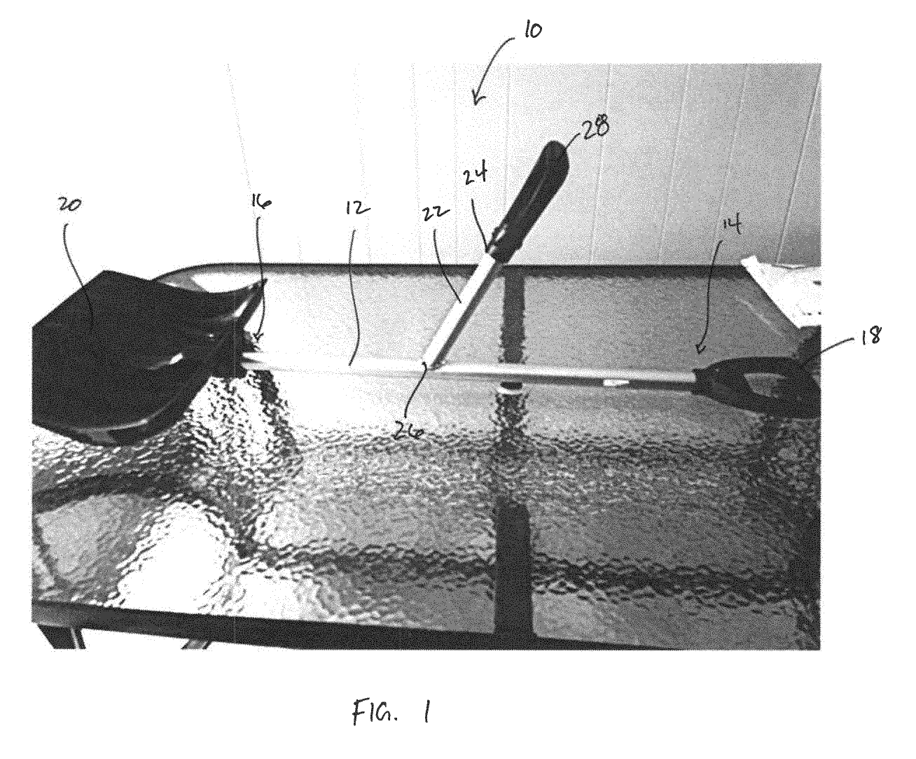

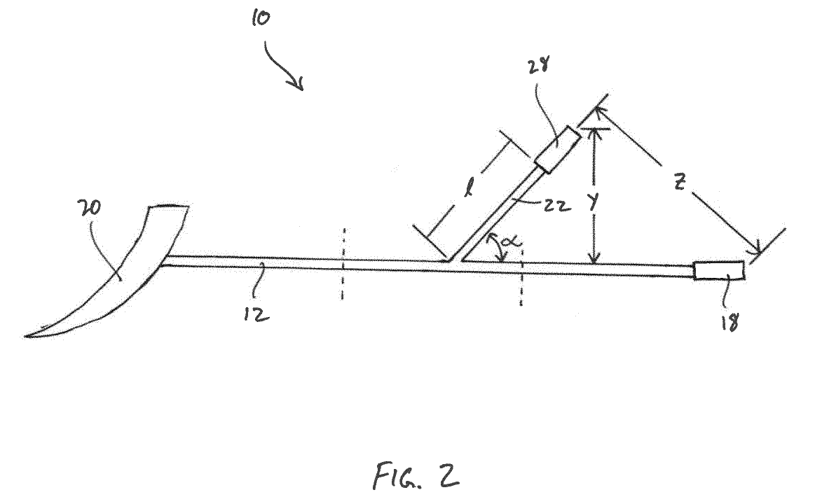

Referring to FIGS. 1 and 2, a utility apparatus 10 according to an embodiment of the present invention is illustrated. The utility apparatus 10 includes an elongated shaft 12 having a first end 14 and a second end 16. A first handle 18 is affixed to the first end 14, and a utility head 20 is affixed to the second end 16. As illustrated in FIGS. 1 and 2, and for ease of illustration, the utility head 20 may be in the form of a shovel and, more particularly, a snow shovel. It is envisioned that the utility head 20, however, may take any form such as, for example, a landscaping rake, an iron gardening rake, a push broom, a pitchfork, a hoe, or other implement.

The utility apparatus 10 further includes an auxiliary or secondary shaft 22 having a first end 24 and a second end 26. The second end 26 of the secondary shaft 22 is affixed to the elongated shaft 12 intermediate the first end 14 and the second end 16 of the elongated shaft 12. In an embodiment, secondary shaft 22 may be affixed to the elongated shaft 12 by welding or using hardware or other mechanical attachment means. In an embodiment, the secondary shaft 22 may be integrally formed with the elongated shaft 12. As further shown in FIGS. 1 and 2, a second handle 28 may be affixed to the first 24 end of the secondary shaft 22.

Through analysis of averages and the 5^{th} and 95^{th} percentile dimensions of United States males and females, the preferred configuration and location of the secondary shaft 22 and second handle 28 that provides the greatest ergonomic benefits for users of the apparatus 10 has been discovered. In particular, with specific reference to FIG. 2, in an embodiment, the elongated shaft 14 may be steel or aluminum tubing, ranging between approximately 24-72 inches in length. In the preferred embodiment (in the case of a snow shovel), the elongated shaft 14 is between approximately 35 inches and 37 inches in length. As illustrated in FIG. 2, in an embodiment, the secondary shaft 22 is preferably affixed to the elongated shaft 14 at some point along the middle third of the elongated shaft 14. In an embodiment, the length, l, of the secondary shaft 22 is between approximately 6 inches and 16 inches and forms an angle, α, of between approximately 40 degrees and 70 degrees with the elongated shaft 14. As further illustrated in FIG. 2, with these specifications, the second handle 28 is therefore located at a distance, y, between approximately 4 inches and 18 inches above the elongated shaft 14, and at a distance, z, between approximately 14 inches and 26 inches from the first handle 18. In the preferred embodiment, the distance, z, from the center of the first handle 18 to the center of the second handle 28 is 21 inches and the distance, y, is 14 inches.

In a preferred embodiment where the utility apparatus is a snow shovel having a snow shovel head, the elongated shaft may be approximately 34.75 inches long and the secondary shaft may be joined to the elongated shaft at approximately 17 inches from the first end 14 of the elongated shaft and the first handle 22. In a preferred embodiment where the utility apparatus is a push broom having a broom head, the elongated shaft may be approximately 58 inches long and the secondary shaft may be joined to the elongated shaft at approximately 28 inches from the first end 14 of the elongated shaft.

In certain embodiments, however, the elongated shaft 12 may be made in different lengths to accommodate different users. In this manner, the apparatus 10 may be a little longer or shorter for people with shorter or longer arms. The present invention may also include a longer bent secondary shaft 28 and may be placed further down the elongated straight shaft 12 toward the shovel blade to accommodate different sized users.

In certain embodiments, the handles 18, 28 may be D-shaped handles. However, the handles 18, 28 may be in any form, such as T-shaped handles and the like. Further, the handles 18, 22 may include finger grips as well as padding. The present invention may come as one piece in which the secondary shaft 22 is welded to the elongated shaft 12, as discussed above. However, in other embodiments, the present invention may include a secondary shaft and handle that can be removably attached to the elongated shaft 22, which would enable retrofitting of the secondary shaft and second handle to any existing shovel or other utility apparatus or implement.

As discussed above, it has been discovered that a utility apparatus, for example, a shovel, having the specific combination of features and the configuration hereinbefore described provides the most optimum ergonomic benefits (i.e., comfortable use) to a user. While various attempts have been made in the past to develop ergonomic tools and other implements, such attempts have typically located the secondary handle too close to the head of the tool, or provided the second hand grip at a distance from the primary hand grip that renders use of the tool very uncomfortable. Indeed, the present invention has discovered the optimal placement of the two handles at roughly shoulder width apart, based on analysis of the physiology of average male and females in the United States. This allows for a significant amount of leverage to be generated during use of the implement, but does not put strain on the shoulders that often results when hand grips are located too far apart.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A utility apparatus, comprising:
an elongated shaft having a first end and a second end;
a first handle affixed to the first end of the elongated shaft;
a utility head affixed to the second end of the elongated shaft;
an auxiliary shaft extending from the elongated shaft, the auxiliary shaft having a first end rigidly affixed to the elongated shaft and a second end opposite the first end; and
a second handle affixed to the second end of the auxiliary shaft;
wherein the auxiliary shaft forms an angle between about 40 degrees and about 70 degrees with the elongated shaft; and
wherein the auxiliary shaft is attached to the elongated shaft at a point along a middle third of the elongated shaft.

2. The utility apparatus of claim 1, wherein:
the second handle is positioned at a distance between about 4 inches and about 18 inches above the elongated shaft; and
the second handle is positioned at a distance between about 14 inches and about 26 inches from the first handle.

3. The utility apparatus of claim 2, wherein:
the second handle is positioned approximately 21 inches from the first handle.

4. The utility apparatus of claim 3, wherein:
the second handle is positioned approximately 14 inches above the elongated shaft.

5. The utility apparatus of claim 4, wherein:
the auxiliary shaft has a length between about 6 inches and 16 inches.

6. The utility apparatus of claim 5, wherein:
the elongated shaft has a length between about 24 inches and about 72 inches.

7. The utility apparatus of claim 6, wherein:
the length of the elongated shaft is approximately 34.75 inches.

8. The utility apparatus of claim 7, wherein:
the utility head is a shovel head; and
the auxiliary shaft is attached to the elongated shaft at a point located approximately 17 inches from the first end of the elongated shaft.

9. The utility apparatus of claim 6, wherein:
the length of the elongated shaft is approximately 58 inches;
the utility head is a broom head; and
the auxiliary shaft is attached to the elongated shaft at a point located approximately 28 inches from the first end of the elongated shaft.

10. The utility apparatus of claim 6, wherein:
the first handle and the second handle are D-shaped handles.

11. The utility apparatus of claim 6, wherein:
the first handle and the second handle are T-shaped handles.

12. The utility apparatus of claim 6, wherein:
the auxiliary shaft is fixedly attached to the elongated shaft.

13. The utility apparatus of claim 6, wherein:
the auxiliary shaft is removable attached to the elongated shaft.

14. The utility apparatus of claims 6, wherein:
the utility head is one of a landscaping rake, a gardening rake, a pitchfork and a hoe.

15. A utility apparatus, comprising:
an elongated shaft having a first end and a second end;
a first handle affixed to the first end of the elongated shaft;
a shovel head affixed to the second end of the elongated shaft;
an auxiliary shaft extending from the elongated shaft, the auxiliary shaft having a first end rigidly affixed to the elongated shaft and a second end opposite the first end; and
a second handle affixed to the second end of the auxiliary shaft;
wherein the auxiliary shaft forms an angle between about 40 degrees and about 70 degrees with the elongated shaft;
wherein the auxiliary shaft is attached to the elongated shaft at a point along a middle third of the elongated shaft;
wherein the second handle is positioned at a distance between about 4 inches and about 18 inches above the elongated shaft; and
wherein the second handle is positioned at a distance between about 14 inches and about 26 inches from the first handle.

16. The utility apparatus of claim 15, wherein:
the second handle is positioned approximately 21 inches from the first handle.

17. The utility apparatus of claim 16, wherein:
the second handle is positioned approximately 14 inches above the elongated shaft.

18. The utility apparatus of claim 17, wherein:
the auxiliary shaft has a length between about 6 inches and 16 inches.

19. The utility apparatus of claim 18, wherein:
the elongated shaft has a length between about 24 inches and about 72 inches.

20. A shovel, comprising:
an elongated shaft having a first end and a second end;
a first handle affixed to the first end of the elongated shaft;
a shovel head affixed to the second end of the elongated shaft;
an auxiliary shaft extending from the elongated shaft, the auxiliary shaft having a first end rigidly affixed to the elongated shaft and a second end opposite the first end; and
a second handle affixed to the second end of the auxiliary shaft;
wherein the auxiliary shaft forms an angle between about 40 degrees and about 70 degrees with the elongated shaft;
wherein the auxiliary shaft is attached to the elongated shaft at a point along a middle third of the elongated shaft;
wherein the elongated shaft has a length between about 24 inches and about 72 inches;
wherein the auxiliary shaft has a length between about 6 inches and 16 inches;
wherein the second handle is positioned approximately 14 inches above the elongated shaft; and
wherein the second handle is positioned at a distance of approximately 21 inches from the first handle.
